(19) United States
(12) Patent Application Publication
(10) Pub. No.: US 2007/0176376 A1
(43) Pub. Date: Aug. 2, 2007

(54) Snow glider

(76) Inventor: Georg Nikolaus Maier, Ottobrunn (DE)

Correspondence Address: WILLIAM COLLARD;COLLARD & ROE, P.C., 1077 NORTHERN BOULEVARD, ROSLYN, NY, 11576, US

(21) Appl. No.: 10/589,368

(22) PCT Filed: Feb. 21, 2005
(86) PCT No.: PCT/EP05/01770

§ 371 Date: Aug. 15, 2006

(30) Foreign Application Priority Data
Feb. 19, 2004 (DE) 10 2004 008 083.6

(51) Int. Cl. B62B 15/00

(52) U.S. Cl. 280/18.1

(57) ABSTRACT

Conventional slow gliders seat only one to maximum two people. The two-seaters are very big and difficult to transport. Binding the sleighs or bobs together involves the risk of injuries, as children can be caught in the ropes and strings when they fal and there is a serious danger of pulled muscles or ligaments and similar injuries. This problem is solved by the inventive snow glider which has a modular set-up. The snow-glider comprises two plate-shaped, circular deepened structures that are disposed in front and in the rear of the snow glider. The deepened structures have the same shape or have at least approximately the same shape and are interlinked via a center part. The front plate-shaped deepened structure is placed in the rear deepened structure of a structurally identical second snow glider or is slid underneath it. When a person sits down on the two superimposed plate-shaped structures, the two plate-shaped structures are held in position by the weight of the person and the snow gliders are interlinked without the need for additional linking material. The feet of the person sitting in the rear are placed on the grip plates of the front snow glider in order to allow for an unimpeded travel. The inventive snow glider allows for maximum enjoyment when the children slide on the snow and adds to the group experience of winter activities.

Children's bobs made of a plastic tray with an integrated seat, also designed as a 2-seater, snow disks with a central handle (DE 1 605 877 B) or also inflatable children's sledging devices are known as popular and fun-promoting children's toys.

However, such toys always offer room for only one or max. 2 persons. The 2-seaters are also very large and are difficult to transport. Furthermore, the children must always ride together, which often leads to disagreements between the children.

When the children play with single-seater bobs or snow disks, they cannot take their younger siblings or friends with them, with the result that there is no communal sledging experience.

Tying sledges or bobs together is always accompanied by an increased risk of injury, since the children could get caught up in the ropes and cords if they crash, leading to a serious risk of pulled muscles or similar injuries.

The objective of the invention is to design a snow glider in such a way that it can be used as a single-seater and also as a multiple-seater.

This problem was solved by designing the snow glider as a modular unit. The snow gliders have a tray-shaped circular recess located one at the front and one at the back, which are designed to be identical or at least approximately identical and which are connected by a central part. The tray-shaped recess at the front is positioned in the rear recess of an identical second snow glider, or else is pushed under the same. When a person sits on one of these two engaged trays, the two parts are kept in position by the weight of this person and the two snow gliders are connected to each other without the need for any other additional connecting material. The feet of the rear person are positioned on the grip plates of the front snow glider in order to allow an unhindered ride.

The inclination at the trays is to be selected in such a way as to allow them to glide in the snow but at the same time to guarantee a secure connection between the two trays.

The engaged circular tray-shaped recesses allow the snow gliders to swivel with respect to each other. This also makes a weaving ride possible, which also increases the children's fun significantly.

The advantage of this invention is that the children enjoy increased fun when using the snow gliders and, depending on the situation, can use them individually or can spontaneously link them up to form any length of chain, without having to use connecting elements. In the event of a crash, the gliders are released from each other again without any additional connecting elements increasing the risk of injury.

One embodiment of the invention is illustrated in the drawing. It shows:

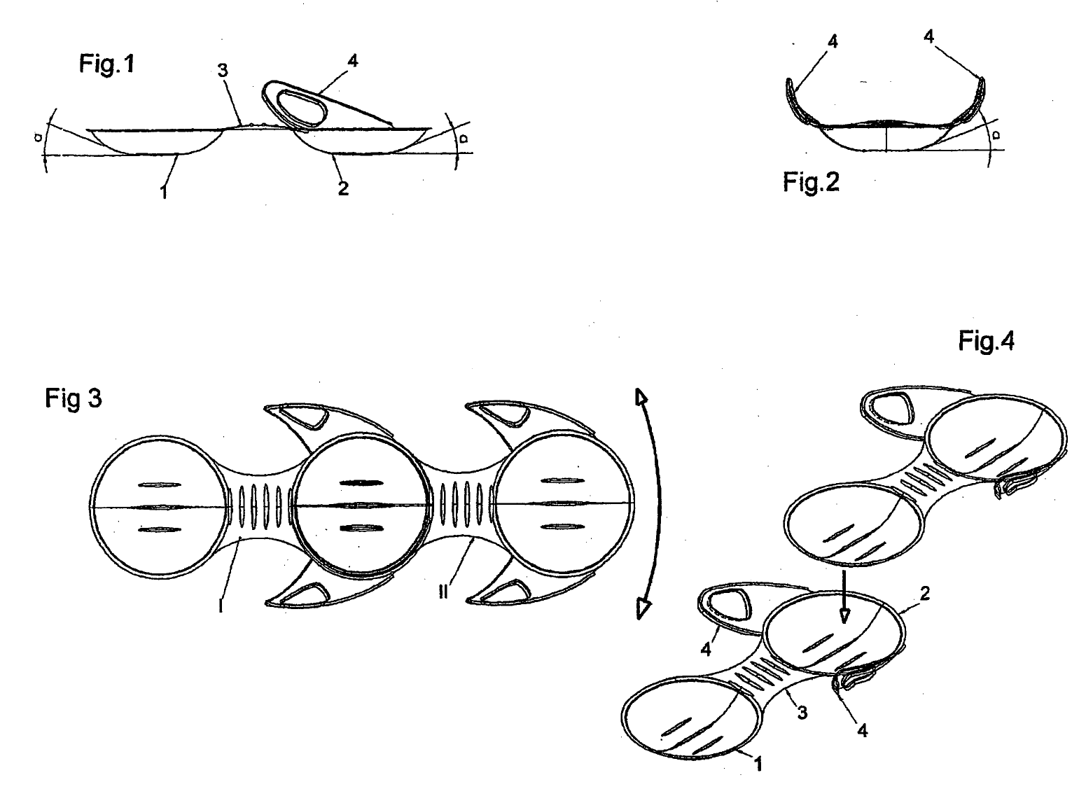

FIG. 1 Side view of the snow glider

FIG. 2 Front view

FIG. 3 Top view of two combined snow gliders

FIG. 4 Perspective view of two gliders

The snow glider has tray-shaped, circular recesses at the front (1) and at the back (2), which are connected by means of a center part (3). Grip plates (4) are mounted on both sides of the rear tray, on the one hand to provide a secure hold during the ride, but also to serve as the foot holder for the person on the next glider when several gliders are combined. The angle of the trays (a) with respect to the ground is to be low enough to make it possible to ride on snow, but on the other hand steep enough to prevent the trays from sliding apart during the ride.

As shown in FIG. 3, a chain of any length can be formed through placing the gliders on top of each other by positioning the front tray of glider II on top of the rear tray of glider I. The feet of the person sitting on glider II can rest on the grip plates of glider I. The circular recess of the trays (I and II) allows the two trays to swivel during the ride.

1-3. (canceled)

4. A snow glider comprising:
a front tray having a front recess;
rear tray having a rear recess with approximately the same shape as the front recess;
a center part connecting the two trays to each other;
wherein two snow gliders can be linked together by placing the rear recess of a first snow glider in the front recess of a second snow glider or placing the front recess of the second snow glider in the rear recess of the first snow glider.

5. A snow glider according to claim 4, wherein the front and rear recesses are each circular, so that when the recesses of different gliders engage each other the recesses allow the snow gliders to swivel with respect to each other and weave as the gliders move.

6. A snow glider according to claim 4, further comprising grip plates mounted on both sides of the rear tray.

7. A modular unit comprising at least two snow gliders according to claim 4, wherein the snow gliders are connected to each other by positioning the rear recess of a first snow glider in the front recess of a second snow glider or positioning the front recess of the second snow glider in the rear recess of the first snow glider.

8. A modular unit in according to claim 7, wherein the engaged recesses of the snow gliders form an articulation to allow the two trays containing the engaged recesses to swivel with respect to each other.

9. A modular unit according to least one front snow glider according to claim 7, further comprising grip plates on the rear tray of each snow glider, said grip plates of one snow glider being designed as foot holders for a person sitting on an snow glider located behind said one snow glider.
